(19) United States
(12) Patent Application Publication
(10) Pub. No.: US 2026/0319874 A1
(43) Pub. Date: Oct. 15, 2026

(54) ELECTRONIC DEVICE AND RECOVERING METHOD THEREOF

(71) Applicant: SK hynix Inc., Gyeonggi-do (KR)

(72) Inventors: Hyun Woo BAE, Gyeonggi-do (KR); Sung Su KIM, Gyeonggi-do (KR)

(21) Appl. No.: 19/454,396

(22) Filed: Jan. 21, 2026

(30) Foreign Application Priority Data
Apr. 14, 2025 (KR) 10-2025-0048191

(51) Int. Cl. G06F 11/07

(52) U.S. Cl. CPC G06F 11/0766; G06F 11/0721

(57) ABSTRACT

An electronic device includes a memory device configured to store data, a first interface configured to transfer and receive the data to and from a host via a first path, a second interface configured to receive recovery data from the host via a second path, and a booting module configured to perform a booting operation, perform, in response to a failure of the booting operation, an analysis operation on the electronic device based on the recovery data to generate analysis result data, and perform a recovery operation on the electronic device based on the recovery data.

### CROSS-REFERENCE TO RELATED APPLICATIONS

The present application claims priority under 35 U.S.C. § 119(a) to Korean patent application number 10-2025-0048191 filed on Apr. 14, 2025, the entire disclosure of which is incorporated by reference herein.

### BACKGROUND

### 1. Technical Field

Various embodiments relate generally to an electronic device, and more particularly, to an electronic device and a recovering method of thereof.

### 2. Related Art

When a booting failure occurs in a storage-based electronic device such as a secure digital (SD) card or a solid state drive (SSD), the electronic device can only be recovered through analysis conducted by a manufacturer.

There are two main methods by which an electronic device communicates with a host device: in-band communication and out-of-band communication. Even if the manufacturer analyzes a booting failure of the electronic device, only limited analysis is possible through in-band communication. Furthermore, the recovery method by the manufacturer causes a user to incur unnecessary time and expense, and also increases the customer service (CS) workload of the manufacturer.

Accordingly, a method of easily analyzing and recovering from the booting failure of the electronic device to increase the reuse rate and lifespan of the electronic devices is discussed.

### SUMMARY

Embodiments of the present disclosure provide an electronic device capable of recovering from and analyzing a booting failure through out-of-band communication.

According to an embodiment, an electronic device may include a memory device configured to store data, a first interface configured to transfer and receive the data to and from a host via a first path, a second interface configured to receive recovery data from the host via a second path, and a booting module configured to perform a booting operation, perform, in response to a failure of the booting operation, an analysis operation on the electronic device based on the recovery data to generate analysis result data, and perform a recovery operation on the electronic device based on the recovery data.

According to an embodiment, a method of operating an electronic device may include applying power to the electronic device, performing a booting sequence, determining whether an error occurs during the booting sequence, receiving, in response to a determination that the error occurs, recovery data through out-of-band communication, analyzing the electronic device based on the recovery data to generate analysis result data, and recovering the electronic device based on the recovery data.

According to an embodiment, an electronic system may include an electronic device including firmware, and a host configured to, in response to a booting failure of the electronic device, transfer recovery firmware to the electronic device via an out-of-band communication path, wherein the electronic device is configured to perform a Built-In-Self-Test (BIST) operation based on the recovery firmware to generate analysis result data, transfer the analysis result data to the host, and recover the firmware based on the recovery firmware.

### BRIEF DESCRIPTION OF THE DRAWINGS

FIG. 1 is a diagram illustrating an electronic system 1000 according to one embodiment of the present disclosure;

FIG. 2 is a diagram illustrating an electronic system 2000 according to one embodiment of the present disclosure;

FIG. 3 is a diagram illustrating an electronic device 200 according to one embodiment of the present disclosure;

FIG. 4 is a diagram illustrating the configuration of a host interface according to one embodiment of the present disclosure;

FIG. 5 is a diagram illustrating a process of receiving recovery data by an electronic device according to one embodiment of the present disclosure;

FIG. 6 is a flowchart illustrating a method of performing a booting sequence by an electronic device according to one embodiment of the present disclosure;

FIG. 7 is a flowchart illustrating a process of receiving recovery data through out-of-band communication in the event of an error while a booting sequence is performed;

FIG. 8 is a flowchart illustrating a method of performing a recovery operation by an electronic device according to one embodiment of the present disclosure; and

FIG. 9 is a cross functional flowchart illustrating a process by which a host adjusts hardware settings of an electronic device according to one embodiment of the present disclosure.

### DETAILED DESCRIPTION

Specific structural or functional descriptions of examples of embodiments in accordance with concepts which are disclosed in this specification are illustrated only to describe the examples of embodiments in accordance with the concepts and the examples of embodiments in accordance with the concepts may be carried out by various forms but the descriptions are not limited to the examples of embodiments described in this specification.

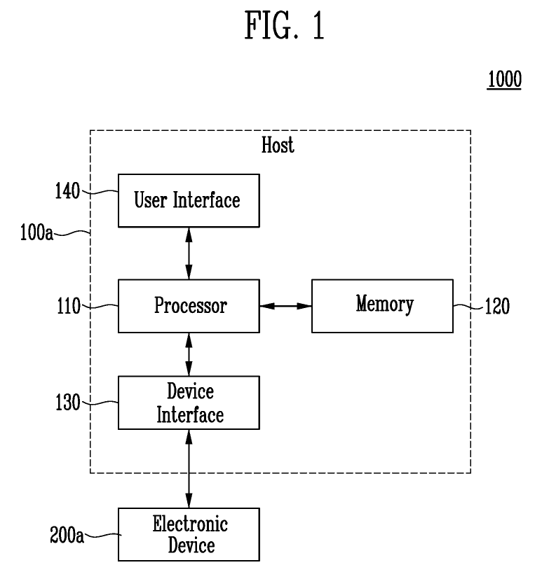

FIG. 1 is a diagram illustrating an electronic system 1000 according to an embodiment of the present disclosure.

The electronic system 1000 may include a host 100a and an electronic device 200a. For example, the host 100a may be configured to control the overall operation of the electronic device 200a.

The host 100a may include a processor 110, a memory 120, a device interface 130, and a user interface 140. For example, the processor 110, the memory 120, and the device interface 130 may be integrated into a single semiconductor integrated circuit (e.g., system-on-chip (SoC)).

The processor 110 may be configured to control the overall operation of the host 100a. For example, the processor 110 may be configured as a system-on-chip (SoC). For example, the processor 110 may include a general purpose processor, a special purpose processor, or the like.

The memory 120 may be an operation memory of the processor 110. The memory 120 may be configured to store codes and data executed by the processor 110. For example, the memory 120 may include read-only memory (ROM) and random access memory (RAM). The RAM may be configured as volatile random access memory, such as dynamic random access memory (DRAM), static random access memory (SRAM), synchronous dynamic random access memory (SDRAM), or the like, or non-volatile random access memory, such as ferroelectric random access memory (FRAM), phase-change random access memory (PRAM), magnetoresistive random access memory (MRAM), resistive random access memory (RRAM), or the like.

The device interface 130 may be configured to mediate communication between the processor 110 and the electronic device 200a.

According to one embodiment, the device interface 130 may include a plurality of communication interfaces. For example, the device interface 130 may include an in-band interface which communicates via an in-band communication path and an out-of-band interface which communicates via an out-of-band communication path. The device interface 130 may perform in-band communication via the in-band interface and out-of-band communication via the out-of-band interface.

For example, in-band communication may include transmitting and receiving data over a band, channel, port, or connection established for data communication between two different devices. Out-of-band communication may include transmitting or receiving data over a band, channel, port, or connection which is not established for data communication between two different devices. For example, through out-of-band communication, data may be transmitted or received in a band (based on frequency, speed, etc.) different to the band used by the in-band communication path.

In one embodiment, out-of-band communication may enable transmission or reception of data over a communication path which is not an in-band communication path (e.g., an input/output (I/O) line which may transfer or receive addresses, commands, addresses, etc. in both directions), but rather a communication path which is reserved for another purpose or use (e.g., a line used for testing, an auxiliary line to supplement the supply of clock or power, etc., a separate line predefined by an agreement between manufacturers or vendors).

In one example, the device interface 130 may communicate with the electronic device 200a using only an in-band communication path. User data and management data for managing the electronic device 200a may be transferred between the device interface 130 and the electronic device 200a over the same communication path.

As shown in FIG. 1, when the device interface 130 is equipped with both an in-band communication path and an out-of-band communication path, user data may be transferred over the in-band communication path and the management data may be transferred over the separately equipped out-of-band communication path. Since the management data is transferred on a separate path which is independent of the path through which the user data is sent or received, the management data may be transferred between the device interface 130 and the electronic device 200a without affecting the transmission of the user data over the in-band communication path. In the present disclosure, the management data may include recovery data for recovering the electronic device 200a.

The electronic device 200a may be configured to communicate with the processor 110 via the device interface 130. The electronic device 200a may be accessible by the processor 110. The electronic device 200a may be a non-volatile memory-based storage device including non-volatile memory.

According to one embodiment, the electronic device 200a may include storage media for storing data in response to a request from the host device 100a. For example, the electronic device 200a may include at least one of a solid state drive (SSD), embedded memory, and removable external memory. When the electronic device 200a is an SSD, the electronic device 200a may conform to the non-volatile memory express (NVMe) standard. When the electronic device 200a is embedded memory or external memory, the electronic device 200a may conform to a universal flash storage (UFS) or embedded multi-media card (eMMC) standard.

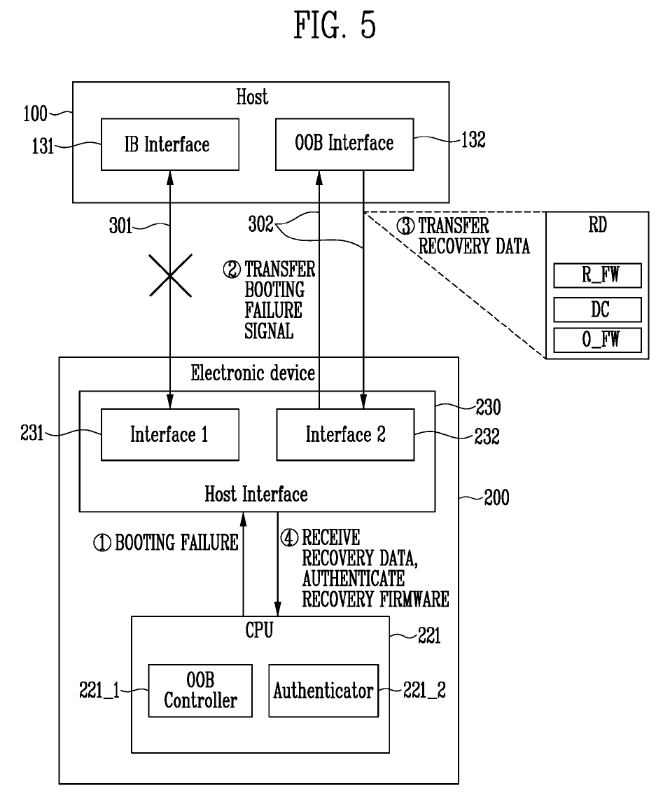

According to one embodiment, in response to a booting failure of the electronic device 200a, the electronic device 200a may receive recovery data through out-of-band communication. Based on the recovery data, the electronic device 200a may perform an analysis of the internal configurations of the electronic device 200a to generate analysis result data. The electronic device 200a may perform a recovery for the booting failure based on the recovery data. For example, the recovery data may be in the form of a binary image and may include recovery firmware. A detailed description of how the electronic device 200a performs recovery via the recovery data will be described below with reference to FIGS. 5-9.

The user interface 140 may communicate with the user under the control of the processor 110. For example, the user interface 140 may include user input interfaces such as a keyboard, a keypad, buttons, a touch panel, a touch screen, a touch pad, a touch ball, a microphone, a sensor, and the like. The user interface 140 may include a device for outputting data or the like to the user, such as a liquid crystal display (LCD), an organic light emitting diode (OLED), a display device, an active matrix OLED (AMOLED) display device, an LED, a speaker, or the like.

The host 100a may further include other components in addition to the above components. For example, the host 100a may further include a network device, a camera module, and the like.

The electronic system 1000 may be configured as a personal computer (PC), a data server, or a portable electronic device. For example, the electronic system 1000 may be configured as a laptop computer, a mobile phone, a smartphone, a tablet PC, a personal digital assistant (PDA), an enterprise digital assistant (EDA), a digital still camera, a digital video camera, a portable multimedia player (PMP), a personal navigation device (PND), or the like.

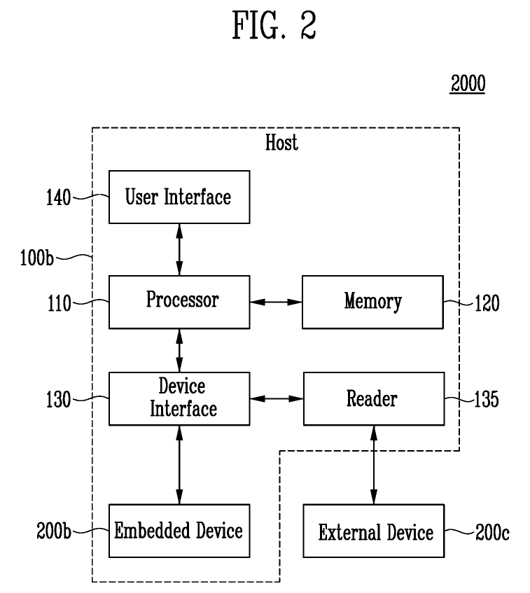

FIG. 2 is a diagram illustrating an electronic system 2000 according to one embodiment of the present disclosure.

The electronic system 2000 may include a host 100b and an external device 200c. For example, the host 100b may be configured to control the overall operation of the external device 200c.

The host 100b may include the processor 110, the memory 120, the device interface 130, the user interface 140, a reader 135, and an embedded device 200b.

The configuration and operation of the electronic system 2000 of FIG. 2 are similar to those of the electronic system 1000 of FIG. 1. Thus, only differences will be described to avoid redundant description.

Compared to the electronic system 1000 of FIG. 1, the electronic system 2000 of FIG. 2 may further include the reader 135. The electronic system 2000 of FIG. 2 may also include both the embedded device 200b and the external device 200c.

The reader 135 may be configured to communicate with the processor 110 via the device interface 130. The reader 135 may be configured to control the external device 200c in response to the control of the processor 110.

The external device 200c may communicate with the processor 110 via the device interface 130, as in the electronic system 1000 of FIG. 1, or may communicate with the processor 110 via the reader 135 and the device interface 130, as in the electronic system 2000 of FIG. 2.

The reader 135 may be configured to communicate with the device interface 130 according to a predetermined communication protocol. For example, the reader 135 may communicate with the device interface 130 according to a USB protocol, but the present disclosure is not limited thereto.

According to one embodiment, the reader 135 may include a plurality of communication interfaces. For example, the reader 135 may include a plurality of communication interfaces respectively including in-band and out-of-band communication paths.

According to one embodiment, each of the embedded device 200b and the external device 200c may receive recovery data through out-of-band communication in response to the booting failure. Based on the recovery data, each of the embedded device 200b and the external device 200c may perform an analysis of the internal configurations of each of the embedded device 200b and the external device 200c to generate analysis result data. Each of the embedded device 200b and the external device 200c may perform recovery for the booting failure based on the recovery data. For example, the recovery data may be in the form of a binary image and may include recovery firmware.

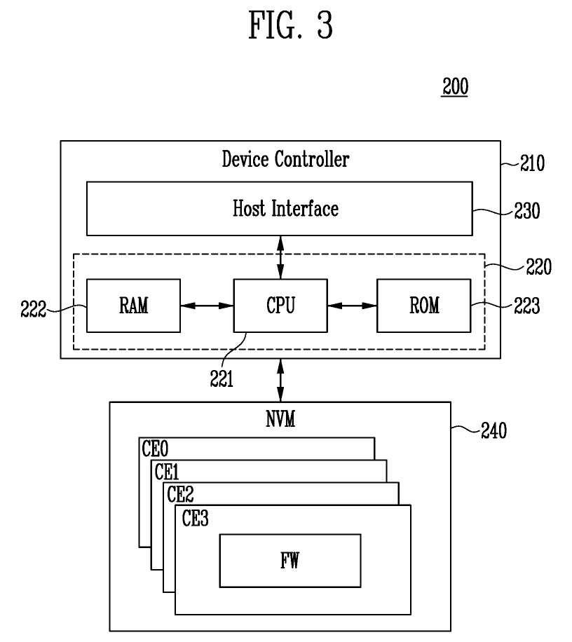

FIG. 3 is a diagram illustrating an electronic device 200 according to one embodiment of the present disclosure. The electronic device 200 may correspond to any of electronic devices 200a, 200b, and 200c, described herein above.

Referring to FIG. 3, the electronic device 200 may include a device controller 210 and non-volatile memory 240.

The device controller 210 may include a booting module 220 and a host interface 230. The booting module 220 may include a CPU 221, RAM 222, and ROM 223. The booting module 220 may be configured to perform a booting operation.

The CPU 221 may be configured to generally control operations of the electronic device 200. For example, the CPU 221 may access the non-volatile memory 250 in response to a command and an address received via the host interface 230.

The RAM 222 may serve as an operation memory for the CPU 221. The RAM 222 may be buffer memory or cache memory. The RAM 222 may include volatile or non-volatile random access memory, such as SRAM, DRAM, SDRAM, FRAM, PRAM, MRAM, RRAM, and the like.

The ROM 223 may store a ROM code. For example, the ROM code may be executed first by the CPU 221 when power is applied to the electronic device 200. For example, the CPU 221 may perform a booting operation on the electronic device 200 to execution of the ROM code.

The host interface 230 may be configured to intermediate communication with the host. For example, the host interface 230 may be configured to receive a command issued by the host, interpret the received command, and generate a response based on the result of the interpretation. The host interface 230 may receive data from the host or transfer data to the host in response to the command. For example, the host interface 230 may be configured to perform in-band communication and out-of-band communication.

According to one embodiment, the non-volatile memory 240 may include NAND flash memory, FRAM, PRAM, MRAM, PRAM, EEPROM, or the like. For example, the non-volatile memory 240 may include a plurality of memory elements CE0 to CE3.

According to one embodiment, the non-volatile memory 240 may be divided into a user storage area where the user may program or read data and a non-user storage area which is not available to the user. For example, the non-user storage area may be configured to store firmware FW. For example, during a booting operation, the CPU 221 may load firmware FW from the non-volatile memory 240 into the RAM 222 and execute the firmware FW.

According to one embodiment, the host interface 230 may be configured to receive the recovery data through out-of-band communication. For example, the CPU 221 may receive the recovery data via the host interface 230 in response to a booting failure. For example, the recovery data may be binary image data including recovery firmware.

The booting module 220 may be configured to, in response to the booting failure, perform an analysis operation based on the recovery data to generate analysis result data and perform a recovery operation based on the recovery data.

For example, the CPU 221 may generate the analysis result data by analyzing states of internal configurations of the electronic device 200 based on the recovery firmware. For example, the CPU 221 may analyze, based on the recovery firmware, the state of each of the RAM 222, the ROM 223, the host interface 230, and the plurality of memory elements CE0 to CE3, and may generate the analysis result data. For example, the CPU 221 may store the generated analysis result data in the non-volatile memory 240 or may transfer the analysis result data from the host via the host interface 230.

For example, the CPU 221 may execute the recovery firmware to recover the electronic device 200 from the booting failure. For example, the recovery data may include original firmware. The original firmware may be the same firmware code as before the firmware FW stored in the non-volatile memory 240 was corrupted. The CPU 221 may update the firmware FW stored in the non-volatile memory 240 with the original firmware in the recovery data, thereby recovering the electronic device 200 from the booting failure.

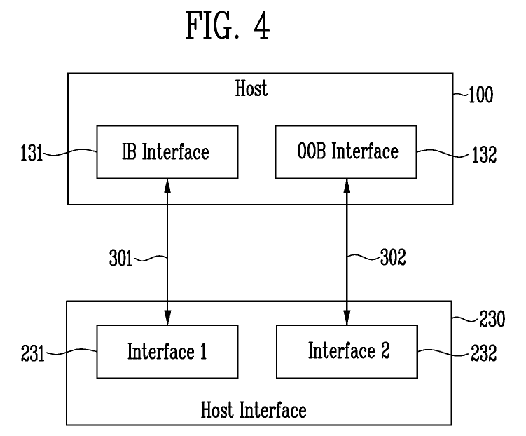

FIG. 4 is a diagram illustrating the configuration of the host interface 230 according to one embodiment of the present disclosure.

Referring to FIG. 4, the host 100 and the host interface 230 may be coupled via an in-band communication path 301 and an out-of-band communication path 302. The host interface 230 of FIG. 4 may have the same configuration as the host interface 230 of FIG. 3, and the electronic device 200 of FIG. 3 may be coupled to the host 100 via the host interface 230.

The host 100 may include an in-band (IB) interface 131 and an out-of-band (OOB) interface 132. For example, the in-band interface 131 may be configured to perform in-band communication and the out-of-band interface 132 may be configured to perform out-of-band communication. For example, the in-band interface 131 may be coupled to the host interface 230 via the in-band communication path 301, and the out-of-band interface 132 may be coupled to the host interface 230 via the out-of-band communication path 302.

The host interface 230 may include a first interface 231 and a second interface 232. For example, the first interface 231 may be coupled to the in-band interface 131 of the host 100 via the in-band communication path 301. For example, the second interface 232 may be coupled to the out-of-band interface 132 of the host 100 via the out-of-band communication path 302.

According to one embodiment, the host 100 may transfer the recovery data to the host interface 230 over the out-of-band communication path 302. For example, the host interface 230 may activate the second interface 232 in response to the booting failure. The host 100 may transfer the recovery data to the second interface 232 via the out-of-band interface 132.

FIG. 5 is a diagram illustrating a process for an electronic device to receive recovery data according to one embodiment of the present disclosure.

Referring to FIG. 5, in response to a booting failure of the electronic device 200 ①, the CPU 221 may transfer a booting failure signal BFS to the host device 100 via the host interface 230 ②.

According to one embodiment, in the event of a booting failure of the electronic device 200 ①, the in-band communication path 301 may be deactivated. In contrast, or additionally, in the event of a booting failure of the electronic device 200, the out-of-band communication path 302 may be activated. For example, the CPU 221 may include an out-of-band communication controller (i.e., OBD controller) 221_1. The out-of-band communication controller 221_1 may be configured to activate the second interface 232 in response to the booting failure. For example, in the event of the booting failure of the electronic device 200, the out-of-band communication controller 221_1 may communicate with the out-of-band interface 132 of the host device 100 via the second interface 232 and the out-of-band communication path 302 (i.e., transfer booting failure signal BFS ②).

In response to the booting failure signal BFS, the host device 100 may transfer recovery data RD to the electronic device 200 ③. For example, the recovery data RD may include recovery firmware R_FW, diagnostic codes DC, and original firmware O_FW. For example, the recovery data RD may be in the form of a binary image.

The CPU 221 may receive the recovery data RD via the second interface 232 ④. For example, the CPU 221 may receive the recovery data RD, and authenticate the recovery firmware R_FW.

According to one embodiment, the CPU 221 may include an authenticator 221_2. For example, the CPU 221 may perform an authentication operation on the recovery firmware R_FW before executing the recovery firmware R_FW. The CPU 221 may be configured to determine whether to use the recovery firmware R_FW based on the result of the authentication operation. For example, when the authentication operation fails, the recovery firmware R_FW may not be used and the recovery operation may be terminated. For example, when the authentication operation succeeds, the recovery firmware R_FW may be used and the recovery operation may be performed.

For example, the authentication operation for the recovery firmware R_FW may include a digital signature verify operation. The signature verify operation may be performed to verify the integrity and authenticity of the recovery firmware R_FW. In the signature verification process, the authenticator 221_2 may verify the digital signature of the recovery firmware R_FW with a public key and determine whether the digital signature is generated by a trusted entity. When the result of the signature verification is valid, the authenticator 221_2 may determine that the verify operation of the recovery firmware R_FW is successful.

According to one embodiment, the CPU 221 may be configured to execute a diagnostic code DC based on the recovery firmware R_FW. For example, the diagnostic code DC may include a Built-In-Self-Test (BIST) operation code, and the CPU may perform a BIST operation via the BIST operation code. For example, the CPU 221 may perform the BIST operation to analyze the internal configurations of the electronic device 200 and generate analysis result data. The CPU 221 may store the generated analysis result data in non-volatile memory.

For example, the BIST operation may verify a normal operation of a core, internal direct memory access (DMA), clock, bus, peripheral, accelerator, etc., inside the electronic device 200. For example, the BIST operation may be performed by executing test logic designed for the memory devices inside the electronic device 200, or by verifying the normal operation of the memory devices through a test algorithm. In addition, the BIST operation may be performed to verify the normal operation of configurations included in the electronic device 200 without external devices.

According to one embodiment, the CPU 221 may be configured to update and store the original firmware O_FW based on the recovery firmware R_FW. For example, the CPU 221 may update the firmware stored in the electronic device 200 with the original firmware O_FW.

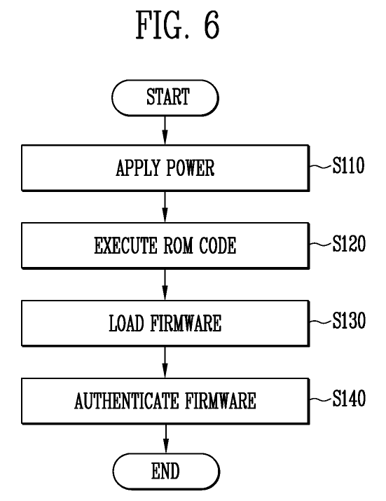

FIG. 6 is a flowchart illustrating a method of performing a booting sequence by an electronic device according to one embodiment of the present disclosure. Hereinafter, the method will be described with reference to FIGS. 3 and 5 together.

Referring to FIG. 6, at operation S110, power may be applied. For example, an external power source may be applied to the electronic device 200.

At operation S120, a ROM code may be executed. For example, the CPU 221 may execute the ROM code stored in the ROM 223. For example, as the ROM code is executed, a booting sequence of the electronic device 200 may be initiated.

At operation S130, firmware may be loaded. For example, the CPU 221 may load the firmware FW stored in a predetermined region of the non-volatile memory 240 into the RAM 222 and execute the firmware FW.

At operation S140, authentication of the firmware may be performed. For example, authentication may be performed on the firmware FW loaded into the RAM 222. Thereafter, the CPU 221 may execute the firmware FW, read Flash Translation Layer (FTL) metadata from the non-volatile memory 240, and check the FTL metadata for errors.

Referring to FIG. 3, according to one embodiment, the CPU 221 may determine whether an error occurs when the booting sequence is performed. For example, the CPU 221 may determine that the error has occurred during the booting sequence when the operations S120 to S140 are not properly performed. For example, at the operation S120, when the ROM code is not executed, the CPU 221 may determine that the error has occurred. For example, at the operation S130, when the firmware is not loaded, the CPU 221 may determine that the error has occurred. For example, at the operation S140, when authentication to the firmware fails, the CPU 221 may determine that the error has occurred.

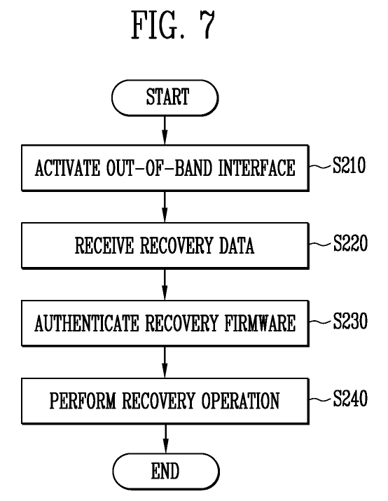

FIG. 7 is a flowchart illustrating a process of receiving recovery data through out-of-band communication when an error occurs during a booting sequence. Hereinafter, the process will be described with reference to FIGS. 3 and 5.

Referring to FIG. 7, at operation S210, an out-of-band interface may be activated. For example, the CPU 221 may determine whether an error has occurred when the electronic device 200 performs a booting sequence. The CPU 221 may activate the second interface 232 when the error has occurred in the booting sequence of the electronic device 200. For example, as the second interface 232 is activated, the host 100 may access the electronic device 200 via the out-of-band communication path 302.

At operation S220, the recovery data may be received. For example, the CPU 221 may receive the recovery data via the second interface 232 and the out-of-band communication path 302. For example, the host 100 may transfer the recovery data via the out-of-band communication path 302. That is, the CPU 221 may receive the recovery data via the out-of-band communication when it is determined that an error has occurred in the booting sequence. For example, the recovery data may be in the form of a binary image. The recovery data may include recovery firmware.

At operation S230, an authentication operation for the recovery firmware may be performed. For example, the CPU 221 may perform the authentication operation on the recovery firmware. For example, when the authentication operation fails, the recovery firmware may not be executed. On the other hand, when the authentication operation is successful, the CPU 221 may execute the recovery firmware.

At operation S240, the recovery operation may be performed. For example, the CPU 221 may analyze the electronic device 200 based on the recovery data, generate analysis result data, and recover the electronic device 200 based on the recovery data. For example, the CPU 221 may execute the recovery firmware to recover the electronic device 200 based on the recovery firmware and may generate the analysis result data.

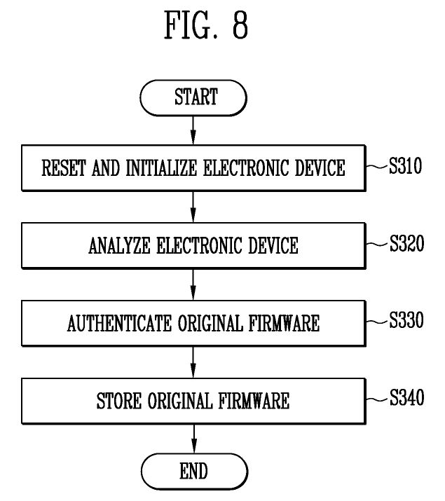

FIG. 8 is a flowchart illustrating a method of performing a recovery operation by an electronic device according to one embodiment of the present disclosure. Hereinafter, the method will be described with reference to FIGS. 3 and 5 together.

Referring to FIG. 8, at operation S310, the electronic device 200 may be reset and initialized. For example, the CPU 221 may reset and initialize the electronic device 200 prior to performing a recovery operation based on the recovery firmware.

At operation S320, the electronic device may be analyzed. For example, the recovery data may include diagnostic codes, and the CPU 221 may execute the diagnostic codes based on the recovery firmware. For example, the diagnostic codes may include a built-in-self-test (BIST) operation code, and the CPU 221 may perform the BIST operation on the electronic device 200 based on the recovery firmware to generate analysis result data. For example, the CPU 221 may store the analysis result data in the non-volatile memory 240. In addition, for example, in response to a request from the host 100, the CPU 221 may provide the analysis result data to the host.

At operation S330, an authentication operation for the original firmware may be performed. For example, the recovery data may include the original data, and the CPU 221 may perform the authentication operation on the original firmware. For example, the verify operation for the original firmware may include a digital signature verify operation. For example, when the authentication operation fails, the recovery operation may terminate.

At operation S340, the original firmware may be updated and stored. For example, the CPU 221 may update the firmware of the electronic device 200 with the original firmware and store the updated original firmware. For example, the CPU 221 may store the original firmware in the recovery data from the RAM 222 to the non-volatile memory 240 based on the recovery firmware. For example, when the CPU 221 performs a booting sequence operation, the updated original firmware may be loaded from the non-volatile memory 240 into the RAM 222 and executed.

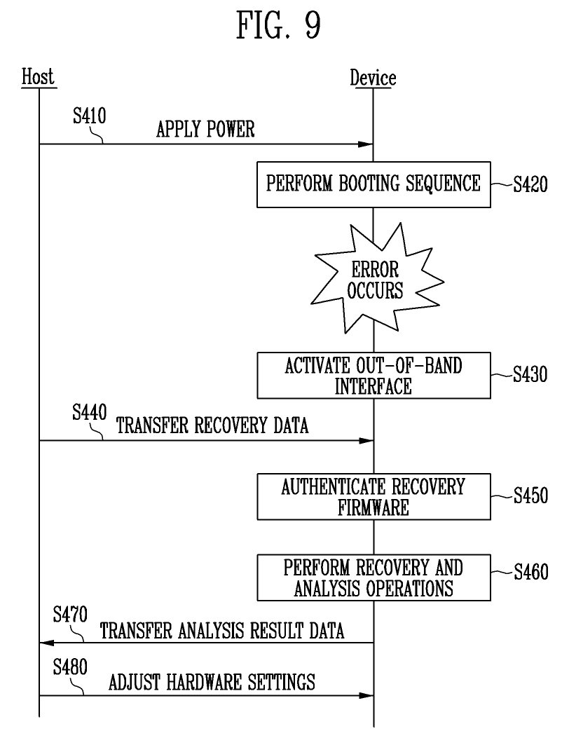

FIG. 9 is a cross functional flowchart illustrating a process by which a host adjusts hardware settings of an electronic device according to an embodiment of the present disclosure. Hereinafter, the process will be described with reference to FIGS. 3 and 5 together.

Referring to FIG. 9, at operation S410, power may be applied. For example, external power may be applied to the electronic device 200.

At operation S420, a booting sequence may be performed. For example, the CPU 221 may perform the booting sequence of the electronic device 200. During the booting sequence, the operations S120 to S140 of FIG. 6 may be performed. The booting sequence may be successful, in which instance the device operates normally, or the booting sequence may be unsuccessful and not be fully performed. For example, while the booting sequence is being performed, an error may occur. The CPU 221 may determine whether the error has occurred during the booting sequence.

At operation S430, the out-of-band interface may be activated. For example, the CPU 221 may activate the second interface 232 in response to the determination that the error has occurred during the booting sequence. With the second interface 232 activated, the host 100 may contact the electronic device 200 via the out-of-band communication path 302.

At operation S440, recovery data may be received. For example, the host 100 may transfer the recovery data to the electronic device 200 over the out-of-band communication path 302. The recovery data may be in the form of a binary image. The recovery data may include recovery firmware, diagnostic codes, and original firmware.

At operation S450, an authentication operation may be performed on the recovery firmware. For example, the authentication operation may include an authentication and/or a verify operation, such as a digital signature verify operation. When the authentication operation is successful, the CPU 221 may execute the recovery firmware.

At operation S460, recovery and analysis operations may be performed by the recovery firmware. For example, the CPU 221 may, based on the recovery firmware, execute diagnostic codes which include BIST operations and may generate analysis result data for the electronic device 200. For example, the CPU 221 may perform an authentication operation on the original firmware, and when the authentication operation is successful, the CPU 221 may update the firmware of the electronic device 200 to the original firmware and store the updated original firmware to perform a recovery operation on the electronic device 200.

At operation S470, the analysis result data may be transferred. For example, when the host 100 requests the analysis result data from the electronic device 200, the CPU 221 may transfer the analysis result data to the host 100. For example, the CPU 221 may transfer the recovery analysis result data via the in-band communication path 301 or the out-of-band communication path 302.

At operation S480, based on the analysis result data, hardware settings of the electronic device 200 may be adjusted. For example, the host device 100 may determine, based on the received the analysis result data, to adjust the hardware settings of the electronic device 200 in response to an error (for example a hardware error) occurring in the internal configurations of the electronic device 200 which do not operate properly. The host 100 may analyze the analysis result data generated in response to a hardware error and implement a response based on the analysis result data. For example, the host 100 may change the hardware (for example, implement alternative hardware) where the error has occurred and may adjust an address value. For example, the host 100 may adjust settings for a physical layer of the communication interface of the electronic device 200. For example, the host 100 may change an address value of the memory where the error has occurred.

According to the present disclosure, an electronic device capable of recovering from and analyzing a booting failure through out-of-band communication may be provided.

As used herein, the term “device” or “unit” refers to any combination of software, firmware, and/or hardware configured to provide the functionality described herein. For example, software may be configured as a software package, code, and/or a set of instructions or commands, and hardware may include a single or any combination or assembly of firmware that stores instructions executed by hardwired circuits, programmable circuits, state machine circuits, and/or programmable circuits.

It will be apparent to those skilled in the art that various modifications can be made to the above-described exemplary embodiments of the present disclosure without departing from the spirit or scope of the invention. Thus, it is intended that the present invention cover all such modifications provided they come within the scope of the appended claims and their equivalents.

What is claimed is:

1. An electronic device comprising:
a memory device configured to store data;
a first interface configured to transfer and receive the data to and from a host via a first path;
a second interface configured to receive recovery data from the host via a second path; and
a booting module configured to:
perform a booting operation,
perform, in response to a failure of the booting operation, an analysis operation on the electronic device based on the recovery data to generate analysis result data, and
perform a recovery operation on the electronic device based on the recovery data.

2. The electronic device of claim 1,
wherein the first path comprises an in-band communication path, and
wherein the second path comprises an out-of-band communication path.

3. The electronic device of claim 1, wherein, in response to the failure of the booting operation, the booting module is configured to activate the second interface.

4. The electronic device of claim 1,
wherein the recovery data comprises recovery firmware,
wherein the booting module is configured to:
perform the analysis operation based on the recovery firmware to generate the analysis result data in response to receipt of the recovery data; and
perform the recovery operation based on the recovery firmware, and
wherein the memory device is configured to store the analysis result data.

5. The electronic device of claim 4, wherein the booting module is configured to perform the analysis operation by performing a Built-In-Self-Test operation based on the recovery firmware.

6. The electronic device of claim 4, wherein the booting module is configured to:
perform an authentication operation on the recovery firmware in response to the receipt the recovery data; and
determine whether to use the recovery firmware based on a result of the authentication operation.

7. The electronic device of claim 1,
wherein the memory device stores first firmware, and
wherein the booting module is configured to perform the booting operation based on the first firmware.

8. The electronic device of claim 7,
wherein the recovery data comprises second firmware, and
wherein the booting module is configured to:
perform an authentication operation on the second firmware in response to receipt of the recovery data; and
determine whether to use the second firmware based on a result of the authentication operation.

9. The electronic device of claim 8, wherein the booting module is configured to update the first firmware stored in the memory device with the second firmware.

10. A method of operating an electronic device, the method comprising:
applying power to the electronic device;
performing a booting sequence;
determining whether an error occurs during the booting sequence;
receiving, in response to a determination that the error occurs, recovery data through out-of-band communication;
analyzing the electronic device based on the recovery data to generate analysis result data; and
recovering the electronic device based on the recovery data.

11. The method of claim 10, further comprising activating, in response to the determination that the error occurs, an out-of-band interface for the out-of-band communication.

12. The method of claim 10,
wherein the recovery data comprises recovery firmware,
wherein the electronic device is analyzed and recovered based on the recovery firmware, and
the method further comprising storing the analysis result data.

13. The method of claim 12, wherein each of the analyzing the electronic device and the recovering the electronic device comprises performing a Built-In-Self-Test operation based on the recovery firmware.

14. The method of claim 12, further comprising performing an authentication operation on the recovery firmware,
wherein each of the electronic device is analyzed and recovered based on a result of the authentication operation on the recovery firmware.

15. The method of claim 10, further comprising:
analyzing the analysis result data in response to a hardware error; and
adjusting hardware settings of the electronic device based on the analysis result data.

16. The method of claim 10, wherein the booting sequence is performed based on first firmware stored in the electronic device.

17. The method of claim 16,
wherein the recovery data comprises second firmware,
the method further comprising performing an authentication operation on the second firmware.

18. The method of claim 17, wherein each of the analyzing the electronic device and the recovering the electronic device comprises replacing the first firmware stored in the electronic device with the second firmware.

19. An electronic system comprising:
an electronic device including firmware; and
a host configured to, in response to a booting failure of the electronic device, transfer recovery firmware to the electronic device via an out-of-band communication path,
wherein the electronic device is configured to
perform a Built-In-Self-Test operation based on the recovery firmware to generate analysis result data,
transfer the analysis result data to the host, and
recover the firmware based on the recovery firmware.

20. The electronic system of claim 19, wherein the host is configured to adjust hardware settings of the electronic device based on the analysis result data.
